(19) United States
(12) Patent Application Publication
(10) Pub. No.: US 2024/0155217 A1
(43) Pub. Date: May 9, 2024

(54) IMAGING APPARATUS

(71) Applicant: SHARP KABUSHIKI KAISHA, Sakai City, Osaka (JP)

(72) Inventor: MUNESATO KUMAGAI, Sakai City, Osaka (JP)

(21) Appl. No.: 18/281,564

(22) PCT Filed: Mar. 30, 2022
(86) PCT No.: PCT/JP2022/015973

§ 371 Date: Sep. 12, 2023

(30) Foreign Application Priority Data
May 26, 2021 (JP) 2021-088473

(51) Int. Cl. H04N 23/57; H04N 23/56; H04N 23/58; H04N 23/65; H04N 23/661; H04N 23/75

(52) U.S. Cl. CPC H04N 23/57; H04N 23/56; H04N 23/58; H04N 23/65; H04N 23/661; H04N 23/75

(57) ABSTRACT

An imaging apparatus includes an imaging device, a support body, and an attachment/detachment mechanism. The imaging device captures an image and generates imaging data. The support body supports the imaging device. The attachment/detachment mechanism temporarily fixes the support body to a cooking apparatus. The cooking apparatus includes a cooking space and a window portion. The cooking space is a space in which food is cooked. The window portion causes the cooking space to be visible. The attachment/detachment mechanism temporarily fixes the support body at a position at which an image of the cooking space can be captured by the imaging device through the window portion.

### TECHNICAL FIELD

The present invention relates to an imaging apparatus.

### BACKGROUND ART

A cooking apparatus with a built-in imaging apparatus is proposed (see PTL 1, for example). For example, a heating device disclosed in PTL 1 includes an imaging unit disposed at the outer side of a door. Specifically, the imaging unit is fixed to a handle portion that assists a gripping operation for opening and closing the door. The imaging unit captures an image of the interior of a heating chamber (cooking chamber) through a viewing window provided at the door.

### CITATION LIST

### Patent Literature

PTL 1: JP 2008-286466 A

### SUMMARY OF INVENTION

### Technical Problem

However, when a configuration is employed in which an imaging apparatus is built in a cooking apparatus, even when the imaging apparatus is built in a cooking apparatus of an existing model, it is necessary to redesign the cooking apparatus. Therefore, a burden on a developer of the cooking apparatus increases.

The present invention has been made in view of the above-described problem, and an object thereof is to provide an imaging apparatus that does not increase a burden on a developer of a cooking apparatus.

### Solution to Problem

An imaging apparatus according to the present invention includes an imaging device, a support body, and an attachment/detachment mechanism. The imaging device is configured to perform image capture and generate imaging data. The support body is configured to support the imaging device. The attachment/detachment mechanism is configured to temporarily fix a cooking apparatus to the support body. The cooking apparatus includes a cooking space and a window portion. The cooking space is a space in which food is cooked. The window portion causes the cooking space to be visible. The attachment/detachment mechanism temporarily fixes the support body at a position at which an image of the cooking space is capturable by the imaging device through the window portion.

### Advantageous Effects of Invention

According to an imaging apparatus of the present invention, a burden on a developer of a cooking apparatus does not increase.

### BRIEF DESCRIPTION OF DRAWINGS

FIG. 1 is a front view illustrating a cooking apparatus to which an imaging apparatus according to a first embodiment of the present invention is temporarily fixed.

FIG. 2 is a side view illustrating the cooking apparatus to which the imaging apparatus according to the first embodiment of the present invention is temporarily fixed.

FIG. 3 is a front view of the imaging apparatus according to the first embodiment of the present invention.

FIG. 4 is a side view of the imaging apparatus according to the first embodiment of the present invention.

FIG. 5 is a diagram schematically illustrating an internal configuration of the imaging apparatus according to the first embodiment of the present invention.

FIG. 6 is a rear view of the imaging apparatus according to the first embodiment of the present invention.

FIG. 7 is a block diagram illustrating a configuration of the imaging apparatus according to the first embodiment of the present invention.

FIG. 8 is a plan view illustrating a cross section of the imaging apparatus temporarily fixed to a window portion of the cooking apparatus.

FIG. 9 is a side view illustrating a cross section of the imaging apparatus temporarily fixed to the window portion of the cooking apparatus.

FIG. 10 is a plan view illustrating a cross section of the imaging apparatus temporarily fixed to the window portion of the cooking apparatus.

FIG. 11 is a plan view illustrating the imaging apparatus before being fixed to the window portion of the cooking apparatus.

FIG. 12 is a front view of the imaging apparatus according to the first embodiment of the present invention.

FIG. 13 is a side view of the imaging apparatus according to the first embodiment of the present invention.

FIG. 14 is a side view of the imaging apparatus according to the first embodiment of the present invention.

FIG. 15 is a rear view of the imaging apparatus according to a second embodiment of the present invention.

FIG. 16 is a block diagram illustrating a configuration of the imaging apparatus according to the second embodiment of the present invention.

FIG. 17 is a front view of the imaging apparatus according to a third embodiment of the present invention.

FIG. 18 is a front view illustrating the cooking apparatus to which the imaging apparatus according to a fourth embodiment of the present invention is temporarily fixed.

FIG. 19 is a side view illustrating the cooking apparatus to which the imaging apparatus according to the fourth embodiment of the present invention is temporarily fixed.

FIG. 20 is a front view illustrating the cooking apparatus to which the imaging apparatus according to a fifth embodiment of the present invention is temporarily fixed.

FIG. 21 is a front view illustrating the cooking apparatus to which the imaging apparatus according to a sixth embodiment of the present invention is temporarily fixed.

FIG. 22 is a side view illustrating a configuration of the imaging apparatus temporarily fixed to the window portion of the cooking apparatus.

FIG. 23 is a diagram illustrating a modified example of a metal plate.

FIG. 24 is a front view illustrating the cooking apparatus to which the imaging apparatus according to a seventh embodiment of the present invention is temporarily fixed.

FIG. 25 is a side view illustrating the imaging apparatus temporarily fixed to the cooking apparatus.

### DESCRIPTION OF EMBODIMENTS

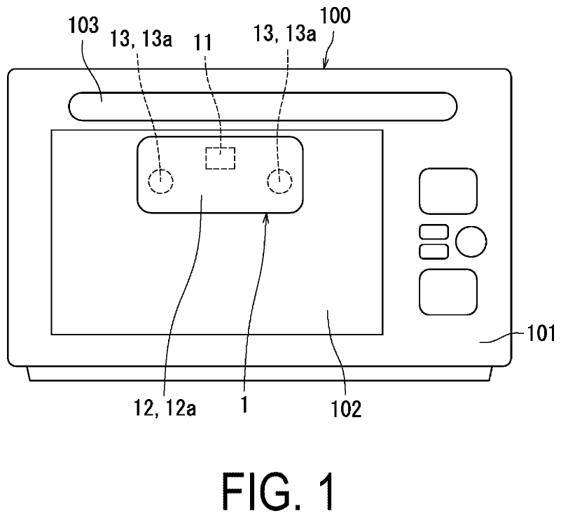

Embodiments according to an imaging apparatus of the present invention will be described below with reference to the accompanying drawings (FIG. 1 to FIG. 25). However, the present invention is not limited to the embodiments described below, and may be implemented in various modes without departing from the gist thereof. Note that redundant description may be omitted as appropriate. In the drawings, the same or equivalent elements are denoted by the same reference signs, and description thereof will not be repeated.

### First Embodiment

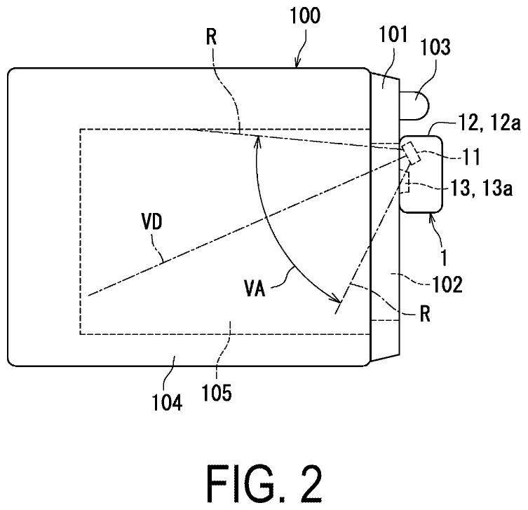

A first embodiment of the present invention will be described below with reference to FIG. 1 to FIG. 14. First, an imaging apparatus 1 of the present embodiment will be described with reference to FIG. 1 to FIG. 2. FIG. 1 is a front view illustrating a cooking apparatus 100 to which the imaging apparatus 1 of the present embodiment is temporarily fixed. FIG. 2 is a side view illustrating the cooking apparatus 100 to which the imaging apparatus 1 of the present embodiment is temporarily fixed.

As illustrated in FIG. 1 and FIG. 2, the cooking apparatus 100 includes a door portion 101, a window portion 102, a handle portion 103, and a main body portion 104 (see FIG. 2). The main body portion 104 includes a cooking chamber 105 (see FIG. 2). The main body portion 104 cooks a food placed in the cooking chamber 105 (cooking space). The cooking apparatus 100 is, for example, a heating cooking apparatus such as a toaster, an oven, or a microwave oven.

The door portion 101 is disposed in front of the main body portion 104, and is attached to the main body portion 104 so that the door portion 101 can be freely opened and closed. In the example illustrated in FIG. 1 and FIG. 2, the door portion 101 is supported by the main body portion 104 so as to be rotatable in the up-down direction. The window portion 102 and the handle portion 103 are provided at the door portion 101. In the example illustrated in FIG. 1 and FIG. 2, the handle portion 103 is disposed above the window portion 102. Note that the door portion 101 may be supported by the main body portion 104 so as to be rotatable in the left-right direction. In this case, the handle portion 103 is disposed to the left or to the right of the window portion 102.

The window portion 102 causes the cooking chamber 105 (cooking space) to be visible from the outside of the cooking apparatus 100. The imaging apparatus 1 of the present embodiment is temporarily fixed to an outer surface of the window portion 102, and captures an image of the cooking chamber 105 through the window portion 102. Therefore, the imaging apparatus 1 can capture an image of a state in which the food is being cooked in the cooking chamber 105.

As illustrated in FIG. 1 and FIG. 2, the imaging apparatus 1 includes an imaging device 11, a support body 12, and an attachment/detachment mechanism 13. The imaging device 11 captures an image of the cooking chamber 105 through the window portion 102, and generates imaging data. The support body 12 supports the imaging device 11 and the attachment/detachment mechanism 13. In the present embodiment, the support body 12 supports the imaging device 11 such that a viewing direction VD (see FIG. 2) of the imaging device 11 is an obliquely downward direction.

The attachment/detachment mechanism 13 temporarily fixes the support body 12 to the cooking apparatus 100. Specifically, the attachment/detachment mechanism 13 temporarily fixes the support body 12 at a position at which the imaging device 11 can capture the image of the cooking chamber 105 (cooking space) through the window portion 102.

In the present embodiment, the support body 12 includes a housing 12a. The attachment/detachment mechanism 13 includes two suction cups 13a. The imaging device 11 is disposed inside the housing 12a.

The suction cup 13a suctions to the outer surface of the window portion 102. The suction cup 13a is attachable to and detachable from the outer surface of the window portion 102. Therefore, the suction cup 13a temporarily fixes the housing 12a (support body 12) to the cooking apparatus 100.

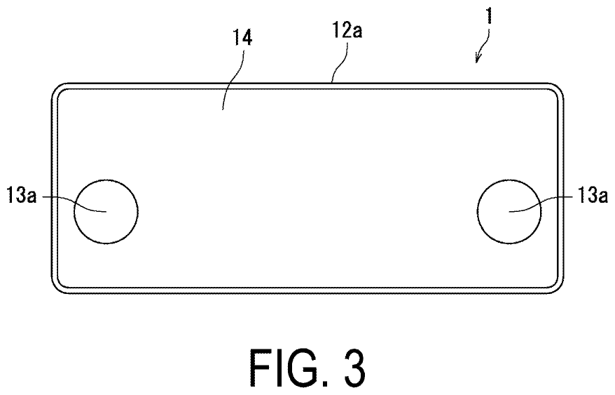

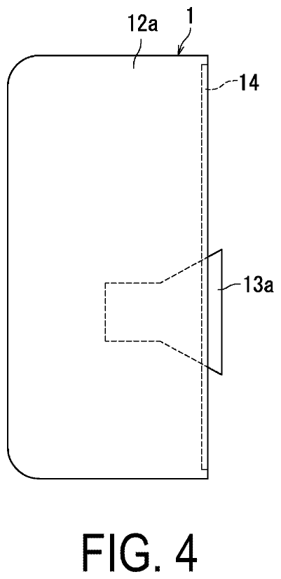

Next, the imaging apparatus 1 will further be described with reference to FIG. 1 to FIG. 4. FIG. 3 is a front view of the imaging apparatus 1 of the present embodiment. FIG. 4 is a side view of the imaging apparatus 1 of the present embodiment. As illustrated in FIG. 3 and FIG. 4, the imaging apparatus 1 further includes a cover portion 14.

The cover portion 14 is disposed at a front surface of the housing 12a. The cover portion 14 is colorless and transparent. The cover portion 14 is made of glass, for example. Alternatively, the cover portion 14 may be made of a colorless and transparent resin. The cover portion 14 faces the window portion 102 in a state in which the imaging apparatus 1 is attached to the cooking apparatus 100.

As illustrated in FIG. 3 and FIG. 4, the suction cups 13a are exposed from the cover portion 14. Further, in a state in which the imaging apparatus 1 is not attached to the cooking apparatus 100, a tip portion of the suction cup 13a protrudes from the cover portion 14. Therefore, the suction cup 13a can be suctioned to the outer surface of the window portion 102.

According to the present embodiment, by causing the suction cups 13a to suction to the outer surface of the window portion 102, a user can temporarily fix the imaging apparatus 1 to the cooking apparatus 100 and can use the imaging apparatus 1 to capture an image of the cooking chamber 105. After finishing capturing the image using the imaging apparatus 1, the user can remove the imaging apparatus 1 from the cooking apparatus 100.

According to the present embodiment, the imaging apparatus 1 is temporarily fixed to the cooking apparatus 100 by the suction cups 13a. Therefore, the user can more easily attach and detach the imaging apparatus 1 to and from the cooking apparatus 100. For example, the user can attach the imaging apparatus 1 to the cooking apparatus 100 by one operation. In addition, the user can remove the imaging apparatus 1 from the cooking apparatus 100 by one operation.

According to the present embodiment, since the imaging apparatus 1 is attachable to and detachable from the cooking apparatus 100, a burden on a developer of the cooking apparatus 100 does not increase. Specifically, in a configuration in which an imaging apparatus is built in a cooking apparatus, it is necessary to redesign the cooking apparatus even when the imaging apparatus is built in a cooking apparatus of an existing model. Specifically, it is necessary to redesign a basic structure such as a chassis and a heat dissipation structure of an apparatus main body, and then, to acquire various certification standards and the like once again. Such work needs to be done for each individual model. Due to the burden of this required work, it becomes difficult to promote product development. On the other hand, according to the present embodiment, since the imaging apparatus 1 is attachable to and detachable from the cooking apparatus 100, there is no need to redesign the cooking apparatus 100, and the burden on the developer of the cooking apparatus 100 does not increase. Thus, the burden for the product development and manufacturing design of the cooking apparatus 100 can be reduced.

According to the present embodiment, since the imaging apparatus 1 is attachable to and detachable from the cooking apparatus 100, an attachment position of the imaging apparatus 1 with respect to the cooking apparatus 100 can be changed. Therefore, an imaging range of the imaging apparatus 1 can be changed. As a result, when the cooking apparatus 100 is a cooking apparatus that can simultaneously perform cooking at a plurality of rack positions arranged in the up-down direction in the cooking chamber 105, the user can capture an image of the food being cooked at any rack position among the plurality of rack positions. On the other hand, in the configuration in which the imaging apparatus is built in the cooking apparatus, since the imaging apparatus cannot be moved, an image of the food being cooked at one specific rack position among the plurality of rack positions can only be captured.

According to the present embodiment, since the imaging apparatus 1 is attachable to and detachable from the cooking apparatus 100, the attachment position of the imaging apparatus 1 can be changed in accordance with the position of the food placed in the cooking chamber 105 (cooking space). Therefore, the image can be captured at an optimum position. On the other hand, in the configuration in which the imaging apparatus is built in the cooking apparatus, the imaging apparatus cannot be moved in accordance with the position of the food.

Further, more and more people are enjoying capturing a picture of a series of cooking steps, from food preparation to completion of cooking, and uploading the video to a social networking service (SNS). However, in the configuration in which the imaging apparatus is built in the cooking apparatus, it is difficult to capture a video of the cooking steps performed outside the cooking apparatus. In addition, when the cooking is performed using a plurality of cooking apparatuses, it is difficult to capture a picture of a state of cooking performed by a cooking apparatus with no built-in imaging apparatus. On the other hand, according to the present embodiment, since the imaging apparatus 1 is attachable to and detachable from the cooking apparatus 100, the video of the cooking steps performed outside the cooking apparatus 100 can be captured. In addition, when the cooking is performed using a plurality of the cooking apparatuses 100, a picture of the cooking chamber 105 (cooking space) of each of the cooking apparatuses 100 can be captured.

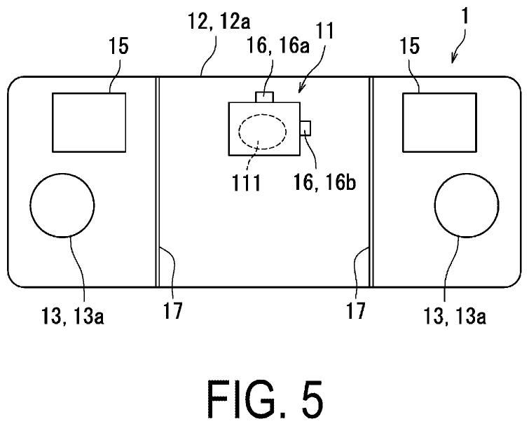

Next, the imaging apparatus 1 of the present embodiment will be further described with reference to FIG. 5. FIG. 5 is a diagram schematically illustrating an internal configuration of the imaging apparatus 1 according to the present embodiment. Specifically, FIG. 5 schematically illustrates the internal configuration of the imaging apparatus 1 viewed from the front. Note that the cover portion 14 described above with reference to FIG. 3 and FIG. 4 is omitted. As illustrated in FIG. 5, the imaging apparatus 1 further includes two illumination units 15, an imaging direction adjustment mechanism 16, and two partition walls 17. Further, the imaging device 11 includes a lens 111.

The lens 111 condenses light incident on the lens 111 from a viewing range R (see FIG. 2) of the imaging device 11 to form an image. The imaging device 11 captures the image formed by the lens 111.

Each of the two illumination units 15 projects light to the viewing range R (see FIG. 2) of the imaging device 11. For example, the illumination unit 15 includes a light-emitting element such as a light emitting diode (LED). When the light-emitting element emits light, the light is emitted from the illumination unit 15. According to the present embodiment, the illumination unit 15 can illuminate the cooking chamber 105 (cooking space). Therefore, the illumination unit 15 can bring the cooking chamber 105 (cooking space) into an environment suitable for the imaging device 11 to capture a picture.

The imaging direction adjustment mechanism 16 adjusts an attachment angle of the imaging device 11 with respect to the support body 12. In the present embodiment, the imaging direction adjustment mechanism 16 adjusts the attachment angle of the imaging device 11 with respect to the housing 12a. Further, in the present embodiment, the imaging direction adjustment mechanism 16 includes a first imaging direction adjustment mechanism 16a and a second imaging direction adjustment mechanism 16b. The first imaging direction adjustment mechanism 16a and the second imaging direction adjustment mechanism 16b are, for example, actuators.

The first imaging direction adjustment mechanism 16a adjusts the attachment angle of the imaging device 11 in the left-right direction. The second imaging direction adjustment mechanism 16b adjusts the attachment angle of the imaging device 11 in the up-down direction.

According to the present embodiment, since the attachment angle of the imaging device 11 with respect to the housing 12a can be adjusted by the imaging direction adjustment mechanism 16, the viewing direction VD (see FIG. 2) of the imaging device 11 can be adjusted.

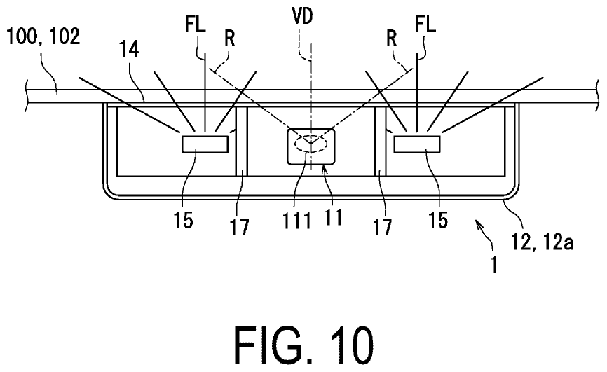

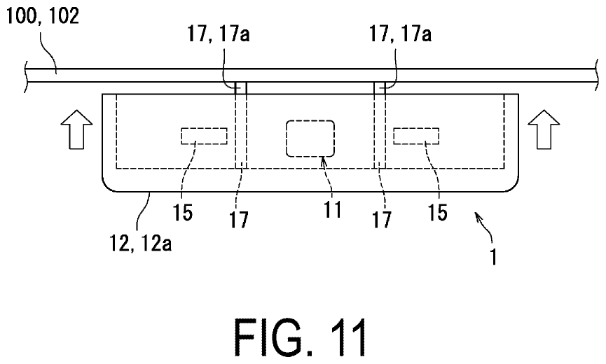

One of the two partition walls 17 is disposed between one of the two illumination units 15 and the imaging device 11. The other of the two partition walls 17 is disposed between the other of the two illumination units 15 and the imaging device 11. The partition walls 17 will be described below with reference to FIG. 10 and FIG. 11.

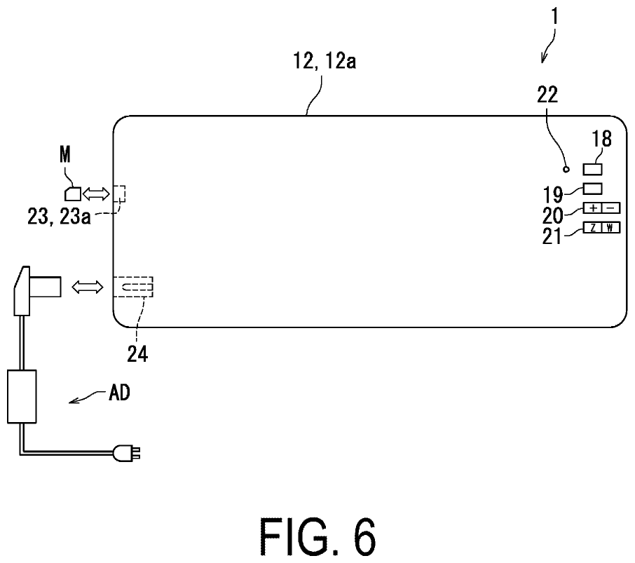

Next, the imaging apparatus 1 of the present embodiment will be further described with reference to FIG. 6. FIG. 6 is a rear view of the imaging apparatus 1 of the present embodiment. As illustrated in FIG. 6, the imaging apparatus 1 further includes a power button 18, a recording button 19, a brightness adjustment button 20, a zoom/wide button 21, a lighting unit 22, an interface unit 23, and a power supply terminal unit 24.

The power button 18, the recording button 19, the brightness adjustment button 20, and the zoom/wide button 21 constitute an operation unit operated by the user. In the present embodiment, the power button 18, the recording button 19, the brightness adjustment button 20, and the zoom/wide button 21 are provided at a rear surface of the housing 12a.

The power button 18 causes a power supply state of the imaging apparatus 1 to transition between an OFF state and an ON state. Specifically, when the power supply state of the imaging apparatus 1 is the OFF state, if the power button 18 is pressed by the user, the power supply state of the imaging apparatus 1 transitions from the OFF state to the ON state, and imaging processing by the imaging device 11 is started. When the power supply state of the imaging apparatus 1 is the ON state, if the power button 18 is pressed by the user, the power supply state of the imaging apparatus 1 transitions from the ON state to the OFF state, and the imaging processing by the imaging device 11 is ended.

The interface unit 23 electrically accesses a storage medium M and transmits the imaging data generated by the imaging device 11 to the storage medium M. In the present embodiment, the interface unit 23 includes a media slot 23a.

The storage medium M is inserted into the media slot 23a. The storage medium M is, for example, a card-shaped storage medium such as a mini SD card or an SD card. In the present embodiment, the media slot 23a is provided at a side surface of the housing 12a, but the position at which the media slot 23a is provided is not limited to the side surface of the housing 12a. For example, the media slot 23a may be provided at an upper surface of the housing 12a.

The recording button 19 is used to instruct the start or end of recording. Specifically, when the recording button 19 is pressed by the user, recording processing of storing the imaging data generated by the imaging device 11 in the storage medium M is started. After the recording is started, when the recording button 19 is pressed by the user, the recording processing is ended.

The lighting unit 22 notifies the user whether or not the imaging apparatus 1 is performing the recording. Specifically, when the recording processing by the imaging apparatus 1 is started, the lighting unit 22 is turned on, and when the recording processing is ended, the lighting unit 22 is turned off. The lighting unit 22 includes a light-emitting element such as an LED, for example.

The brightness adjustment button 20 is used to instruct the start or end of illumination of the illumination unit 15. The brightness adjustment button 20 is also used to instruct a change in a light amount of light emitted from the illumination unit 15.

Specifically, when the illumination unit 15 is turned off, if the brightness adjustment button 20 is pressed by the user, light of a predetermined light amount is emitted from the illumination unit 15. The brightness adjustment button 20 includes a light amount increase button (+) and a light amount reduction button (−). After the illumination unit 15 is turned on, when the light amount increase button (+) is pressed by the user, the light amount of the light emitted from the illumination unit 15 increases. After the illumination unit 15 is turned on, when the light amount reduction button (−) is pressed by the user, the light amount of the light emitted from the illumination unit 15 decreases. After the light amount of the light emitted from the illumination unit 15 is reduced to a predetermined minimum light amount, when the light amount reduction button (−) is pressed, the illumination unit 15 is turned off.

According to the present embodiment, the light amount of the light emitted from the illumination unit 15 can be controlled. Therefore, the user can control the light amount in accordance with the environment in which a picture is captured, and can capture the picture with a desired brightness.

The zoom/wide button 21 is used to instruct a change in the viewing range R (see FIG. 2) of the imaging device 11. Specifically, the imaging device 11 has a zoom function. When the zoom/wide button 21 is pressed, the focal distance of the imaging device 11 (lens 111) changes, and a viewing angle VA (see FIG. 2) changes accordingly, the viewing angle VA being an angle (angle of view) of the viewing range R of the imaging device 11.

Specifically, the zoom/wide button 21 includes a zoom button (Z) and a wide button (W). When the zoom button (Z) is pressed by the user, the focal distance is increased. When the wide button (W) is pressed by the user, the focal distance is shortened. Note that the focal distance of the imaging device 11 obtained when the power supply state of the imaging apparatus 1 transitions from the OFF state to the ON state is set in advance.

According to the present embodiment, the viewing range R of the imaging device 11 can be changed. Therefore, the user can switch between telephoto and wide-angle modes in accordance with the environment in which a video is captured, and can capture the picture in a desired manner.

The power supply terminal unit 24 is an example of a power supply interface unit, and an external power supply line is detachably connected to the power supply terminal unit 24. The external power supply line supplies power to the power supply terminal unit 24. The imaging apparatus 1 operates based on the power supplied to the power supply terminal unit 24. In the present embodiment, an AC adapter AD is connected to the power supply terminal unit 24. The AC adapter AD is an example of the external power supply line.

According to the present embodiment, the external power supply line is detachably connected to the imaging apparatus 1. Therefore, when the imaging apparatus 1 is not in use, the external power supply line can be detached from the imaging apparatus 1. As a result, the imaging apparatus 1 can be easily stored in a kitchen, for example.

In the present embodiment, the power supply terminal unit 24 is provided at a side surface of the housing 12a, but the position at which the power supply terminal unit 24 is provided is not limited to the side surface of the housing 12a. For example, the power supply terminal unit 24 may be provided at a lower surface of the housing 12a.

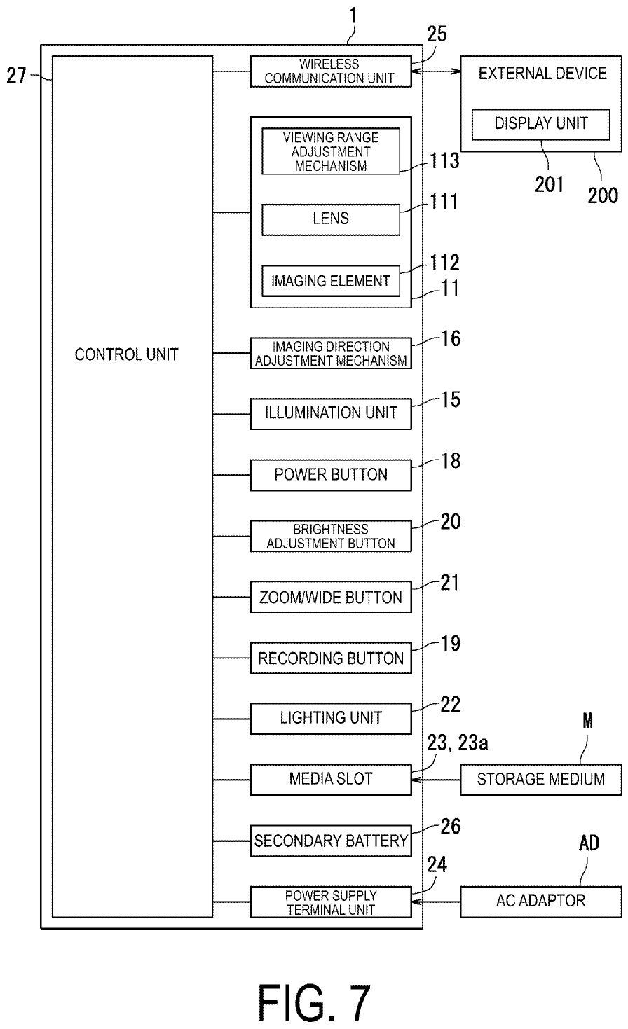

Next, the imaging apparatus 1 of the present embodiment will be described with reference to FIG. 7. FIG. 7 is a block diagram illustrating a configuration of the imaging apparatus 1 according to the present embodiment. As illustrated in FIG. 7, the imaging apparatus 1 further includes a wireless communication unit 25, a secondary battery 26, and a control unit 27. Further, the imaging device 11 further includes an imaging element 112 and a viewing range adjustment mechanism 113.

Examples of the imaging element 112 include a charge coupled device (CCD) sensor or a complementary metal oxide semiconductor (CMOS) sensor. The viewing range adjustment mechanism 113 adjusts the viewing range R (see FIG. 2). Specifically, the viewing range adjustment mechanism 113 moves the lens 111 to adjust the distance (focal distance) between the lens 111 and a light receiving surface of the imaging element 112. The viewing range adjustment mechanism 113 is, for example, an actuator.

The wireless communication unit 25 wirelessly communicates with an external device 200. Specifically, the wireless communication unit 25 performs wireless communication conforming to a predetermined communication standard. The predetermined communication standard is, for example, a wireless local area network (LAN) standard such as Wi-Fi (trademark). The wireless communication unit 25 includes, for example, a wireless LAN board or a wireless LAN module.

The control unit 27 controls the imaging device 11, the illumination unit 15, the imaging direction adjustment mechanism 16, the lighting unit 22, and the wireless communication unit 25. The control unit 27 also controls the storage medium M via the media slot 23a. The control unit 27 includes a processor such as a central processing unit (CPU) or a micro processing unit (MPU), for example. Alternatively, the control unit 27 may include a microcomputer or may include dedicated hardware.

When the control unit 27 includes the processor, the control unit 27 further includes a memory. Various computer programs to be executed by the processor and various data are stored in the memory.

The memory is, for example, a semiconductor memory. The semiconductor memory includes, for example, a random access memory (RAM) and a read only memory (ROM). Alternatively, instead of or in addition to the RAM and the ROM, the semiconductor memory may include at least one of a flash memory, an erasable programmable read only memory (EPROM), and an electrically erasable programmable read-only memory (EEPROM).

When the control unit 27 includes the dedicated hardware, the control unit 27 may be, for example, a single circuit, a composite circuit, a programmed processor, a parallel-programmed processor, an application specific integrated circuit (ASIC), a field-programmable gate array (FPGA), or a circuit obtained by combining these components.

The power supplied from the AC adapter AD (external power supply line) to the power supply terminal unit 24 is supplied to the imaging device 11, the illumination unit 15, the imaging direction adjustment mechanism 16, and the wireless communication unit 25 via the control unit 27. The imaging device 11, the illumination unit 15, the imaging direction adjustment mechanism 16, and the wireless communication unit 25 operate based on the power supplied to the power supply terminal unit 24.

The control unit 27 stores, in the secondary battery 26, some of the power supplied to the power supply terminal unit 24. When the AC adapter AD (external power supply line) is not connected to the power supply terminal unit 24, the control unit 27 supplies the power stored in the secondary battery 26 to the imaging device 11, the illumination unit 15, the imaging direction adjustment mechanism 16, and the wireless communication unit 25. Therefore, when the AC adapter AD (external power supply line) is not connected to the power supply terminal unit 24, the imaging device 11, the illumination unit 15, the imaging direction adjustment mechanism 16, and the wireless communication unit 25 operate based on the power supplied from the secondary battery 26.

According to the present embodiment, since the imaging apparatus 1 includes the secondary battery 26, an image can be captured even in a state in which the AC adapter AD (external power supply line) is not connected to the power supply terminal unit 24. In this case, a cooking operation by a cook is not disturbed by the external power supply line.

The control unit 27 transmits and receives data to and from the external device 200 via the wireless communication unit 25. Specifically, the control unit 27 transmits the imaging data that has been output from the imaging device 11 to the control unit 27, to the external device 200 via the wireless communication unit 25.

The external device 200 includes a display unit 201. The external device 200 causes the display unit 201 to display the video captured by the imaging apparatus 1 based on the imaging data received from the imaging apparatus 1. The external device 200 is a device which can process information, such as a smartphone, a tablet terminal, or a personal computer (PC). The external device 200 is not particularly limited as long as it is a device which can perform wireless communication and displaying the video captured by the imaging apparatus 1.

According to the present embodiment, the video captured by the imaging apparatus 1 can be displayed on the external device 200. Therefore, the user can check the progress of cooking at a place away from the cooking apparatus 100. Thus, the user does not necessarily stay near the cooking apparatus 100 from the start to the end of the cooking in order to check the progress of the cooking.

The control unit 27 receives control signals from the external device 200 via the wireless communication unit 25. The control unit 27 controls the imaging device 11, the illumination unit 15, the imaging direction adjustment mechanism 16, and the storage medium M based on the control signals. Therefore, the user can remotely operate the imaging apparatus 1. Specifically, the control signals include first to eighth control signals.

The first control signal is a signal for instructing a transition in the power supply state of the imaging apparatus 1. Based on the first control signal, the control unit 27 causes the power supply state of the imaging apparatus 1 to transition between the OFF state and the ON state.

The second control signal is a signal for instructing the start of the recording. Based on the second control signal, the control unit 27 stores the imaging data generated by the imaging device 11 in the storage medium M. When the recording is started, the control unit 27 turns on the lighting unit 22.

The third control signal is a signal for instructing the end of the recording. Based on the third control signal, the control unit 27 ends the processing of storing the imaging data in the storage medium M. Note that when the recording is stopped, the control unit 27 turns off the lighting unit 22.

The fourth control signal is a signal for instructing the start of the illumination of the illumination unit 15. Based on the fourth control signal, the control unit 27 turns on the illumination unit 15.

The fifth control signal is a signal for instructing the change in the light amount of the light emitted from the illumination unit 15. The fifth control signal is an example of a light amount instruction signal. Based on the fifth control signal, the control unit 27 controls the light amount of the light emitted from illumination unit 15. For example, when the illumination unit 15 includes the LED as the light-emitting element, the control unit 27 controls the current supplied to the LED to control the light amount of the light emitted from the illumination unit 15.

The sixth control signal is a signal for instructing the end of the illumination of the illumination unit 15. Based on the sixth control signal, the control unit 27 turns off the illumination unit 15.

The seventh control signal is a signal for instructing the change in the viewing range R (see FIG. 2) of the imaging device 11. The seventh control signal is an example of a viewing range instruction signal. Based on the seventh control signal, the control unit 27 controls the viewing range adjustment mechanism 113 in order to change the viewing range R.

The eighth control signal is a signal for instructing a change in the attachment angle of the imaging device 11 with respect to the housing 12a. The eighth control signal is an example of an attachment angle instruction signal. Based on the eighth control signal, the control unit 27 controls the imaging direction adjustment mechanism 16 to change the attachment angle of the imaging device 11. As a result, the viewing direction VD of the imaging device 11 changes.

Next, the control unit 27 will be further described with reference to FIG. 7. The control unit 27 executes processing corresponding to the user's operation with respect to the power button 18, the recording button 19, the brightness adjustment button 20, and the zoom/wide button 21.

Specifically, when the power supply state of the imaging apparatus 1 is the OFF state, if the power button 18 is pressed by the user, the control unit 27 starts supplying the power to the imaging device 11, the illumination unit 15, the imaging direction adjustment mechanism 16, and the wireless communication unit 25. When the power supply state of the imaging apparatus 1 is the ON state, if the power button 18 is pressed by the user, the control unit 27 stops supplying the power to the imaging device 11, the illumination unit 15, the imaging direction adjustment mechanism 16, and the wireless communication unit 25.

When the recording button 19 is pressed by the user, the control unit 27 starts the recording processing of storing the imaging data in the storage medium M. After the recording is started, when the recording button 19 is pressed by the user, the recording processing is ended.

When the illumination unit 15 is not turned on, if the brightness adjustment button 20 is pressed by the user, the control unit 27 causes the illumination unit 15 to emit light. After the illumination unit 15 is turned on, when the light amount increase button (+) is pressed by the user, the control unit 27 increases the light amount of the light emitted from the illumination unit 15. After the illumination unit 15 is turned on, when the light amount reduction button (−) is pressed by the user, the light amount of the light emitted from the illumination unit 15 is reduced. After the light amount of the light emitted from the illumination unit 15 is reduced to the predetermined minimum light amount, when the light amount reduction button (−) is pressed, the illumination unit 15 is turned off.

When the zoom button (Z) of the zoom/wide button 21 is pressed by the user, the control unit 27 controls the viewing range adjustment mechanism 113 to increase the focal distance. When the wide button (W) of the zoom/wide button 21 is pressed by the user, the control unit 27 controls the viewing range adjustment mechanism 113 to shorten the focal distance.

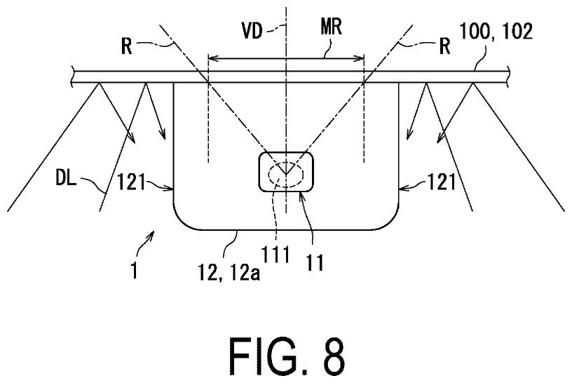

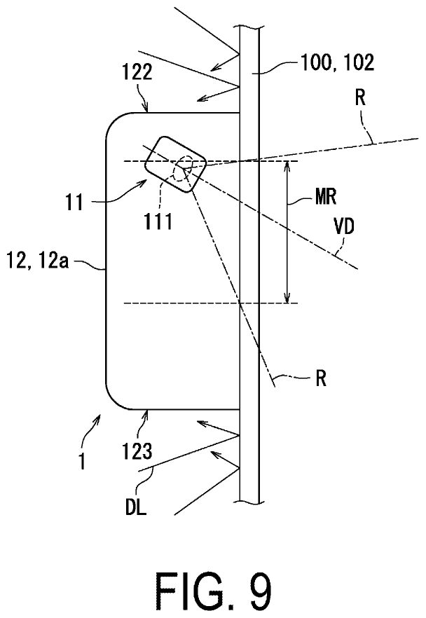

Next, the imaging apparatus 1 of the present embodiment will be described with reference to FIG. 8 and FIG. 9. FIG. 8 is a plan view illustrating a cross section of the imaging apparatus 1 temporarily fixed to the window portion 102 of the cooking apparatus 100. However, for ease of understanding, the attachment/detachment mechanism 13, the cover portion 14, the illumination units 15, the imaging direction adjustment mechanism 16, and the partition walls 17 are omitted in FIG. 8. As illustrated in FIG. 8, the housing 12a includes sidewall portions 121. The sidewall portions 121 are portions of the support body 12.

The sidewall portion 121 functions as a blackout portion. Specifically, the sidewall portion 121 suppresses reflected light DL reflected by the window portion 102 of the cooking apparatus 100 from entering the viewing range R of the imaging device 11.

Specifically, when light from the outside of the cooking apparatus 100 is reflected in a region MR on the inner side of a boundary along which the viewing range R and the window portion 102 intersect each other, the reflected light DL is incident on the viewing range R. As a result, an unwanted image from the outside of the cooking apparatus 100 is captured by the imaging device 11. On the other hand, in the present embodiment, the sidewall portions 121 suppress the light from the outside of the cooking apparatus 100 from being reflected in the region MR. In other words, the sidewall portions 121 suppress the light from the outside of the cooking apparatus 100 from entering the region MR. Therefore, the unwanted image is less likely to be included in the video captured by the imaging device 11.

FIG. 9 is a side view illustrating a cross section of the imaging apparatus 1 temporarily fixed to the window portion 102 of the cooking apparatus 100. However, for ease of understanding, the attachment/detachment mechanism 13, the cover portion 14, the illumination units 15, the imaging direction adjustment mechanism 16, and the partition walls 17 are omitted in FIG. 9. As illustrated in FIG. 9, the housing 12a further includes an upper wall portion 122 and a lower wall portion 123. The upper wall portion 122 and the lower wall portion 123 are portions of the support body 12.

The upper wall portion 122 and the lower wall portion 123 function as the blackout portions. Specifically, the upper wall portion 122 and the lower wall portion 123 suppress the reflected light DL reflected by the window portion 102 of the cooking apparatus 100 from entering the viewing range R of the imaging device 11. Specifically, similarly to the sidewall portions 121, the upper wall portion 122 and the lower wall portion 123 suppress the light from the outside of the cooking apparatus 100 from being reflected in the region MR. Therefore, the unwanted image is less likely to be included in the video captured by the imaging device 11.

Next, the partition walls 17 will be described with reference to FIG. 10. FIG. 10 is a plan view illustrating a cross section of the imaging apparatus 1 temporarily fixed to the window portion 102 of the cooking apparatus 100. However, for ease of understanding, the attachment/detachment mechanism 13 and the imaging direction adjustment mechanism 16 are omitted in FIG. 10.

As illustrated in FIG. 10, the partition walls 17 block light FL emitted from the illumination unit 15, inside the housing 12a. Specifically, the partition walls 17 suppress the light FL emitted from the illumination unit 15 from leaking into the viewing range R of the imaging device 11 inside the housing 12a. Therefore, the light FL emitted from the illumination unit 15 is less likely to be included in the video captured by the imaging device 11.

Note that, even when the partition walls 17 are not provided, by increasing the distance between the illumination unit 15 and the imaging device 11, the light FL emitted from the illumination unit 15 can be suppressed from leaking into the viewing range R of the imaging device 11 inside the housing 12a. However, in this case, the size of the imaging apparatus 1 is increased. On the other hand, when the partition walls 17 are provided, the light FL emitted from the illumination unit 15 can be suppressed from leaking into the viewing range R of the imaging device 11 inside the housing 12a, without increasing the size of the imaging apparatus 1.

Next, the partition walls 17 will be further described with reference to FIG. 11. FIG. 11 is a plan view illustrating the imaging apparatus 1 before being fixed to the window portion 102 of the cooking apparatus 100. However, for ease of understanding, the attachment/detachment mechanism 13, the cover portion 14, and the imaging direction adjustment mechanism 16 are omitted in FIG. 11.

As illustrated in FIG. 11, a tip portion 17a of the partition wall 17 protrudes from the front surface of the housing 12a. In other words, the tip portion 17a of the partition wall 17 protrudes from the outer surface (front surface) of the cover portion 14 (see FIG. 10). The partition wall 17 is formed of a material having flexibility. Therefore, when the imaging apparatus 1 is fixed to the window portion 102 of the cooking apparatus 100, the partition wall 17 is deformed and the tip portion 17a of the partition wall 17 comes into close contact with the window portion 102 of the cooking apparatus 100. As a result, the light FL emitted from the illumination unit 15 can more reliably be suppressed from leaking into the viewing range R of the imaging device 11 inside the housing 12a.

Note that, similarly to the partition wall 17, tip portions of the sidewall portion 121 (see FIG. 8), the upper wall portion 122 (see FIG. 9), and the lower wall portion 123 (see FIG. 9) of the housing 12a may protrude from the front surface of the housing 12a. Further, similarly to the partition wall 17, the sidewall portion 121 (see FIG. 8), the upper wall portion 122 (see FIG. 9), and the lower wall portion 123 (see FIG. 9) of the housing 12a may each be formed of a material having flexibility. With such a configuration, the reflected light DL reflected by the window portion 102 of the cooking apparatus 100 can more reliably be suppressed from entering the viewing range R of the imaging device 11.

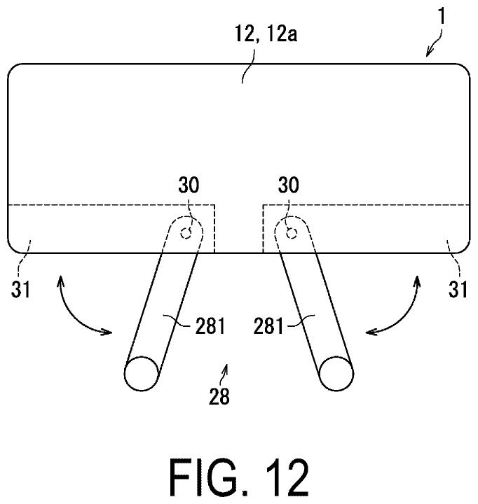

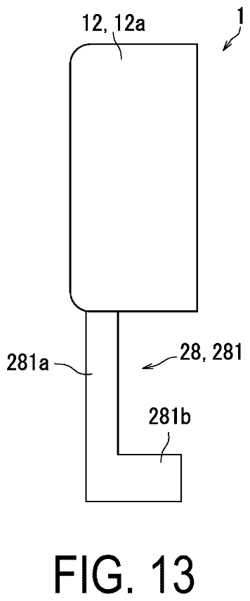

Next, the imaging apparatus 1 of the present embodiment will be further described with reference to FIG. 12 and FIG. 13. FIG. 12 is a front view of the imaging apparatus 1 of the present embodiment. However, the attachment/detachment mechanism 13 (suction cups 13a) and the cover portion 14 are omitted in FIG. 12. FIG. 13 is a side view of the imaging apparatus 1 of the present embodiment. However, the attachment/detachment mechanism 13 (suction cups 13a) is omitted in FIG. 13. As illustrated in FIG. 12 and FIG. 13, the imaging apparatus 1 further includes a first self-standing mechanism 28. The first self-standing mechanism 28 causes the support body 12 (housing 12a) to stand by itself. Therefore, the imaging apparatus 1 can stand by itself using the first self-standing mechanism 28.

Specifically, as illustrated in FIG. 12, the first self-standing mechanism 28 includes two leg portions 281. The imaging apparatus 1 further includes two shaft portions 30. The housing 12a has two housing portions 31.

The two leg portions 281 are rotatably supported by the two shaft portions 30, respectively. More specifically, the shaft portion 30 rotatably supports a base end portion of the leg portion 281. The leg portion 281 is rotatable about the shaft portion 30.

The two housing portions 31 are provided at a lower portion of the housing 12a. The interior of each of the two housing portions 31 is hollow. The two shaft portions 30 are disposed in the two housing portions 31, respectively. Each of the two shaft portions 30 is supported by the housing 12a.

Each of the two leg portions 281 is rotatable between a housed position and a self-standing position thereof. The housed position indicates a position at which the leg portion 281 is housed in the housing portion 31. The self-standing position indicates a position at which a portion of the leg portion 281 protrudes obliquely downward from the housing 12a (housing portion 31).

As illustrated in FIG. 13, the leg portion 281 includes a support portion 281a and a base portion 281b. Each of the support portion 281a and the base portion 281b has a rod shape. The base portion 281b protrudes, from a tip portion of the support portion 281a, in a direction orthogonal to a direction in which the support portion 281a extends.

According to the present embodiment, the imaging apparatus 1 can stand by itself using the first self-standing mechanism 28. Therefore, the imaging apparatus 1 can capture the picture of the cooking steps performed outside the cooking apparatus 100 in a stable posture. Further, since the leg portion 281 of the first self-standing mechanism 28 includes the base portion 281b, the imaging apparatus 1 can be caused to stand by itself in a more stable manner.

Note that the number of the leg portions 281 of the first self-standing mechanism 28 is not limited to two. The first self-standing mechanism 28 may include three or more of the leg portions 281.

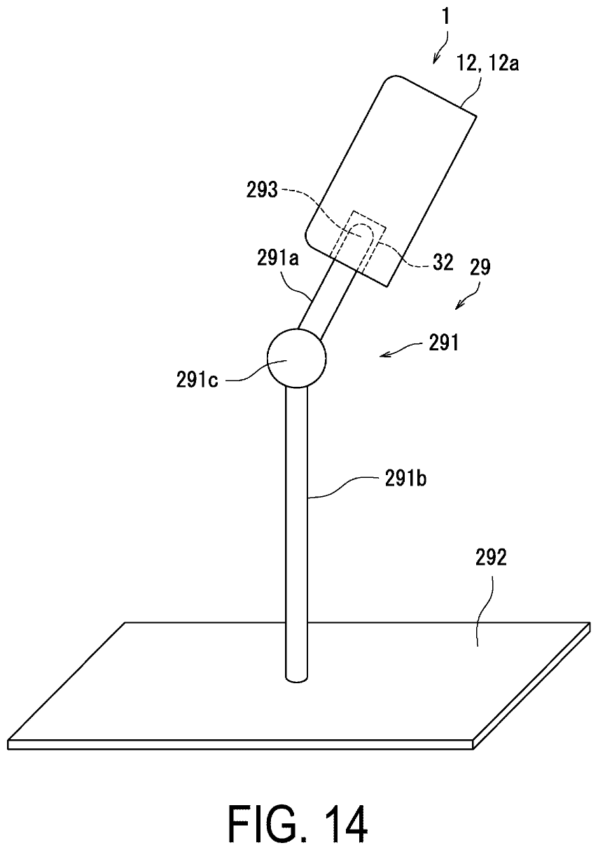

Next, the imaging apparatus 1 of the present embodiment will be further described with reference to FIG. 14. FIG. 14 is a side view of the imaging apparatus 1 of the present embodiment. However, the attachment/detachment mechanism 13 (suction cups 13a) is omitted in FIG. 14. As illustrated in FIG. 14, the imaging apparatus 1 further includes a second self-standing mechanism 29. The second self-standing mechanism 29 causes the support body 12 (housing 12a) to stand by itself. Therefore, the imaging apparatus 1 can stand by itself using the second self-standing mechanism 29.

Specifically, the second self-standing mechanism 29 includes a leg portion 291 and a base portion 292. The housing 12a further includes a connecting portion 32. The connecting portion 32 is provided at the lower portion of the housing 12a.

An upper end portion of the leg portion 291 is detachably connected to the connecting portion 32. As a result of the upper end portion of the leg portion 291 being connected to the connecting portion 32, the leg portion 291 is temporarily fixed to the housing 12a. A lower end portion of the leg portion 291 is fixed to the base portion 292. The base portion 292 has a flat-plate shape.

In the present embodiment, the leg portion 291 includes a first leg portion 291a, a second leg portion 291b, and a posture adjustment mechanism 291c. Each of the first leg portion 291a and the second leg portion 291b has a rod shape.

A tip portion 293 of the first leg portion 291a is detachably connected to the connecting portion 32. For example, the tip portion 293 of the first leg portion 291a may be screwed with the connecting portion 32. In this case, the connecting portion 32 is a screw hole, and a screw groove is formed at the peripheral surface of the tip portion 293 of the first leg portion 291a.

A base end portion of the first leg portion 291a is supported by the posture adjustment mechanism 291c. The posture adjustment mechanism 291c is provided at a tip portion of the second leg portion 291b. In other words, the tip portion of the second leg portion 291b is connected to the posture adjustment mechanism 291c. A base end portion of the second leg portion 291b is fixed to the base portion 292. The posture adjustment mechanism 291c adjusts the posture of the housing 12a (support body 12).

For example, the posture adjustment mechanism 291c may support the first leg portion 291a such that the first leg portion 291a is rotatable about the posture adjustment mechanism 291c in the up-down direction. In this way, the viewing direction VD of the imaging device 11 is changeable.

Alternatively, the posture adjustment mechanism 291c may support the first leg portion 291a such that the first leg portion 291a is rotatable about the axial center of the first leg portion 291a. In this way, the viewing direction VD of the imaging device 11 is changeable.

According to the present embodiment, the imaging apparatus 1 can stand by itself using the second self-standing mechanism 29. Therefore, the imaging apparatus 1 can capture the picture of the cooking steps performed outside the cooking apparatus 100 in a stable posture.

Note that, although the imaging apparatus 1 includes the first self-standing mechanism 28 and the second self-standing mechanism 29 in the present embodiment, the imaging apparatus 1 may include one of the first self-standing mechanism 28 and the second self-standing mechanism 29. Further, the posture adjustment mechanism 291c of the second self-standing mechanism 29 may be omitted.

The first embodiment of the present invention has been described above with reference to FIG. 1 to FIG. 14. Note that, in the present embodiment, the attachment/detachment mechanism 13 includes the two suction cups 13a, but the number of the suction cups 13a is not limited to two. The number of the suction cups 13a is not particularly limited as long as the imaging apparatus 1 can be attached to the cooking apparatus 100. For example, the number of the suction cups 13a may be one, or three or more.

### Second Embodiment

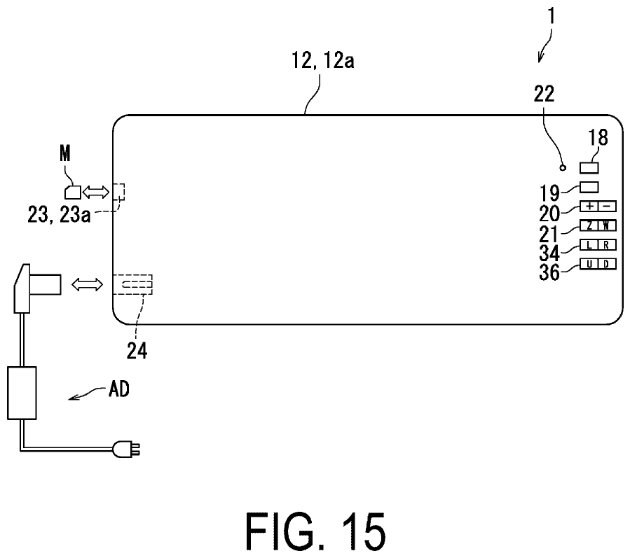

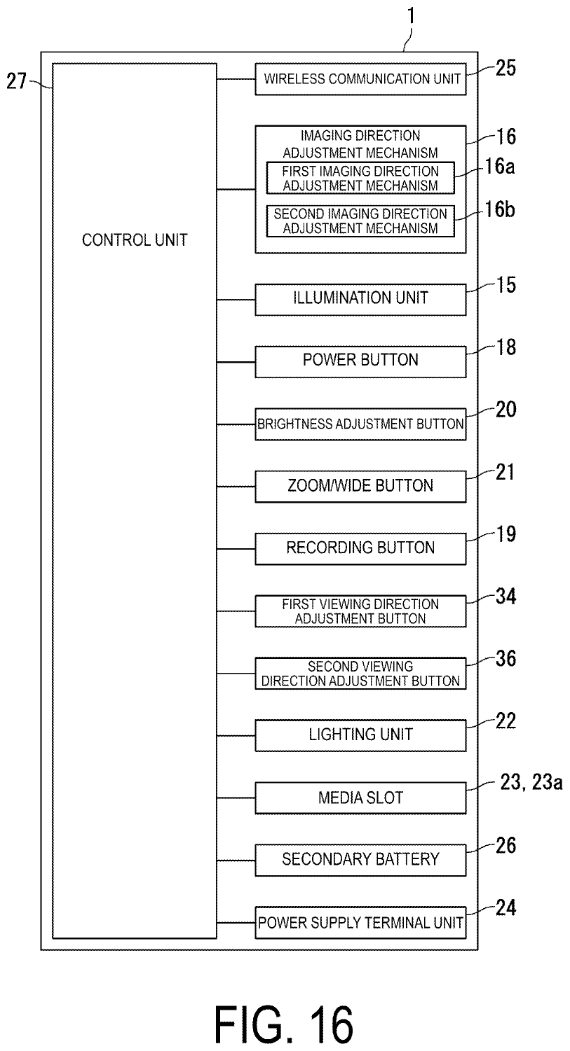

Next, a second embodiment of the present invention will be described with reference to FIG. 15 and FIG. 16. Note that elements different from those of the first embodiment will be described, and description of the same elements as those of the first embodiment will be omitted. In the second embodiment, the operation unit of the imaging apparatus 1 is different from that of the first embodiment.

FIG. 15 is a rear view of the imaging apparatus 1 of the present embodiment. As illustrated in FIG. 15, the imaging apparatus 1 further includes a first viewing direction adjustment button 34 and a second viewing direction adjustment button 36. The first viewing direction adjustment button 34 and the second viewing direction adjustment button 36 are provided at the rear surface of the housing 12a.

The first viewing direction adjustment button 34 is used to instruct a change in the viewing direction VD of the imaging device 11 in the left-right direction. Specifically, the first viewing direction adjustment button 34 includes an L button and an R button. When the L button is pressed by the user, the viewing direction VD of the imaging device 11 is displaced to the left. When the R button is pressed by the user, the viewing direction VD of the imaging device 11 is displaced to the right.

The second viewing direction adjustment button 36 is used to instruct a change in the viewing direction VD of the imaging device 11 in the up-down direction. Specifically, the second viewing direction adjustment button 36 includes an up button (U) and a down button (D). When the up button (U) is pressed by the user, the viewing direction VD of the imaging device 11 is displaced upward. When the down button (D) is pressed by the user, the viewing direction VD of the imaging device 11 is displaced downward.

Note that the viewing direction VD of the imaging device 11 obtained when the power supply state of the imaging apparatus 1 transitions from the OFF state to the ON state is set in advance.

Next, processing executed by the control unit 27 included in the imaging apparatus 1 according to the present embodiment will be described with reference to FIG. 16. FIG. 16 is a block diagram illustrating a configuration of the imaging apparatus 1 according to the present embodiment.

In the present embodiment, the processing executed by the control unit 27 further includes processing corresponding to the user's operation with respect to the first viewing direction adjustment button 34 and the second viewing direction adjustment button 36.

Specifically, when the first viewing direction adjustment button 34 is pressed by the user, the control unit 27 controls the first imaging direction adjustment mechanism 16a to change the attachment angle of the imaging device 11 with respect to the housing 12a in the left-right direction. As a result, the viewing direction VD of the imaging device 11 is displaced in the left-right direction.

When the second viewing direction adjustment button 36 is pressed by the user, the control unit 27 controls the second imaging direction adjustment mechanism 16b to change the attachment angle of the imaging device 11 with respect to the housing 12a in the up-down direction. As a result, the viewing direction VD of the imaging device 11 is displaced in the up-down direction.

The second embodiment of the present invention has been described above with reference to FIG. 15 and FIG. 16. According to the present embodiment, the viewing direction VD of the imaging device 11 can be changed. Therefore, the user can change the viewing direction VD in accordance with the environment in which an image is captured, and can capture the picture in a desired manner.

### Third Embodiment

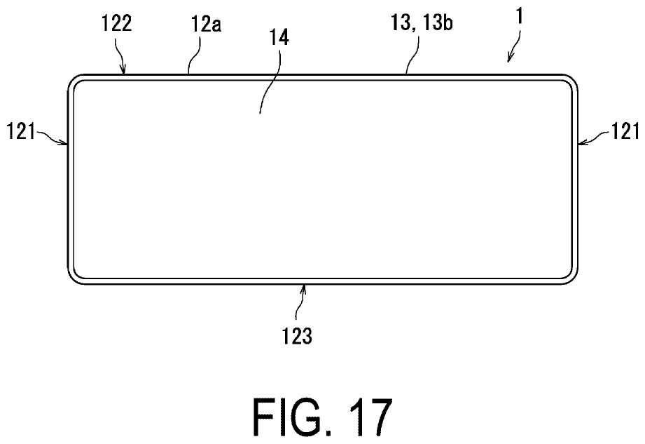

Next, a third embodiment of the present invention will be described with reference to FIG. 17. Note that elements different from those of the first embodiment and second embodiment will be described, and description of the same elements as those of the first embodiment and second embodiment will be omitted. In the third embodiment, the configuration of the attachment/detachment mechanism 13 is different from those of the first and second embodiments.

FIG. 17 is a front view of the imaging apparatus 1 of the present embodiment. In the present embodiment, the attachment/detachment mechanism 13 includes a suction cup 13b. The suction cup 13b is provided on the front surface side of the housing 12a and surrounds the cover portion 14. More specifically, a suction material is continuously provided at the respective tip portions (end portions on the cooking apparatus 100 side) of the sidewall portions 121, the upper wall portion 122, and the lower wall portion 123 of the housing 12a.

The suction cup 13b suctions to the outer surface of the window portion 102 (see FIG. 1 and FIG. 2) of the cooking apparatus 100. The suction cup 13b is attachable to and detachable from the outer surface of the window portion 102 of the cooking apparatus 100. Thus, the suction cup 13b temporarily fixes the housing 12a to the cooking apparatus 100.

Further, the suction cup 13b functions as the blackout portion. Specifically, the suction cup 13b suppresses the reflected light DL (see FIG. 8 and FIG. 9) reflected by the window portion 102 of the cooking apparatus 100 from entering the viewing range R (see FIG. 8 and FIG. 9) of the imaging device 11.

The third embodiment of the present invention has been described above with reference to FIG. 17. Similarly to the first embodiment, according to the present embodiment, since the imaging apparatus 1 is attachable to and detachable from the cooking apparatus 100, the burden on the developer of the cooking apparatus 100 does not increase.

Note that, in the present embodiment, the attachment/detachment mechanism 13 includes the suction cup (suction cup 13b) surrounding the cover portion 14, but the attachment/detachment mechanism 13 may include a suction cup (suction material) surrounding the imaging device 11 instead of the suction cup 13b or in addition to the suction cup 13b. As a result of the suction cup surrounding the imaging device 11, the light FL (see FIG. 10) emitted from the illumination unit 15 can be suppressed from leaking into the viewing range R (see FIG. 10) of the imaging device 11 inside the housing 12a. Therefore, in this case, the partition walls 17 may be omitted.

### Fourth Embodiment

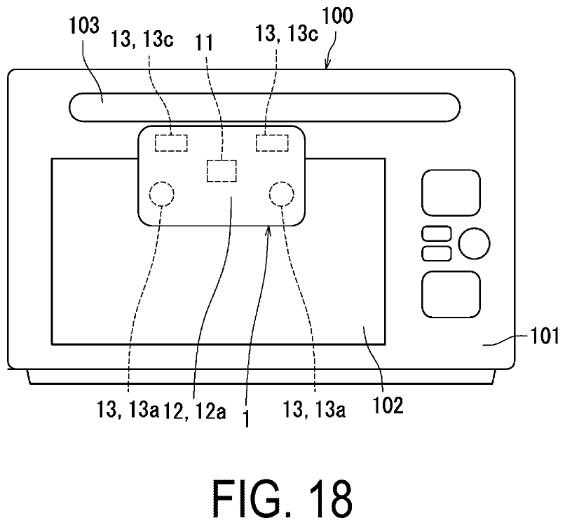

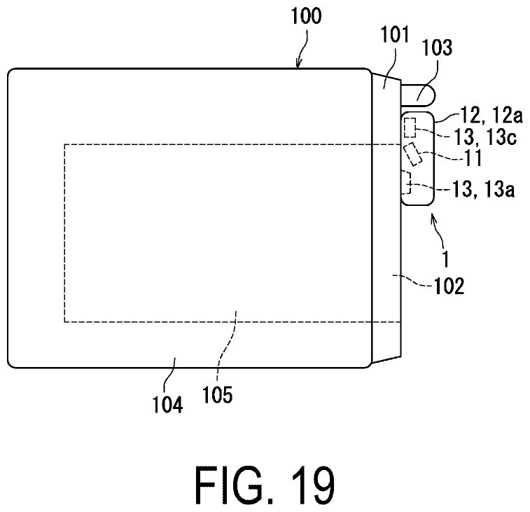

Next, a fourth embodiment of the present invention will be described with reference to FIG. 18 and FIG. 19. Note that elements different from those of the first to third embodiments will be described, and description of the same elements as those of the first to third embodiments will be omitted. In the fourth embodiment, the configuration of the attachment/detachment mechanism 13 is different from those of the first to third embodiments.

FIG. 18 is a front view illustrating the cooking apparatus 100 to which the imaging apparatus 1 of the present embodiment is temporarily fixed. FIG. 19 is a side view illustrating the cooking apparatus 100 to which the imaging apparatus 1 of the present embodiment is temporarily fixed. As illustrated in FIG. 18 and FIG. 19, in the imaging apparatus 1 of the present embodiment, the attachment/detachment mechanism 13 includes the two suction cups 13a and two magnets 13c.

The support body 12 (housing 12a) supports the two magnets 13c. The two magnets 13c are disposed at an upper portion of the housing 12a. More specifically, the two magnets 13c are disposed on the inner side of the housing 12a and above the two suction cups 13a, respectively.

The magnets 13c are stuck to the outer surface of the door portion 101 via the cover portion 14 described above with reference to FIG. 3 and FIG. 4. The magnet 13c is attachable to and detachable from the outer surface of the door portion 101. Therefore, the attachment/detachment mechanism 13 (suction cups 13a and magnets 13c) temporarily fixes the housing 12a (support body 12) to the cooking apparatus 100.

The fourth embodiment of the present invention has been described above with reference to FIG. 18 and FIG. 19. Similarly to the first embodiment, according to the present embodiment, since the imaging apparatus 1 is attachable to and detachable from the cooking apparatus 100, the burden on the developer of the cooking apparatus 100 does not increase. Further, according to the present embodiment, since the attachment/detachment mechanism 13 includes the magnets 13c in addition to the suction cups 13a, the imaging apparatus 1 can be attached to the cooking apparatus 100 in a more stable manner.

Note that, in the present embodiment, the two magnets 13c stuck to the door portion 101 above the window portion 102. However, the positions at which the two magnets 13c are stuck to the door portion 101 are not particularly limited as long as the imaging apparatus 1 can be attached to the cooking apparatus 100.

Further, the number of the suction cups 13a is not limited to two. The number of the suction cups 13a is not particularly limited as long as the imaging apparatus 1 can be attached to the cooking apparatus 100. For example, the number of the suction cups 13a may be one, or three or more.

Similarly, the number of the magnets 13c is not limited to two. The number of the magnets 13c is not particularly limited as long as the imaging apparatus 1 can be attached to the cooking apparatus 100. For example, the number of the magnets 13c may be one, or three or more.

### Fifth Embodiment

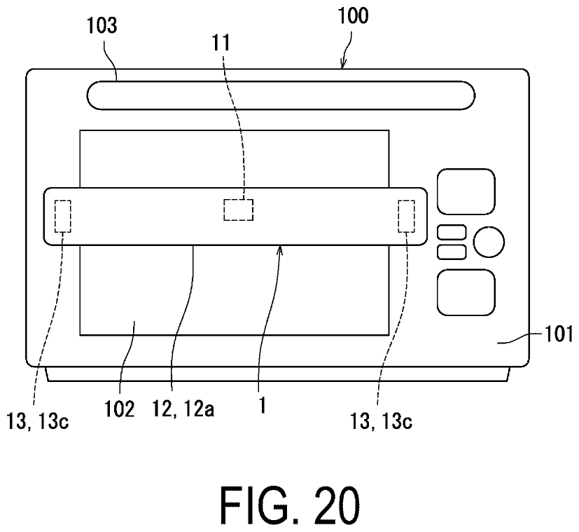

Next, a fifth embodiment of the present invention will be described with reference to FIG. 20. Note that elements different from those of the first to fourth embodiments will be described, and description of the same elements as those of the first to fourth embodiments will be omitted. In the fifth embodiment, the configuration of the attachment/detachment mechanism 13 is different from those of the first to fourth embodiments.

FIG. 20 is a front view illustrating the cooking apparatus 100 to which the imaging apparatus 1 of the present embodiment is temporarily fixed. As illustrated in FIG. 20, in the imaging apparatus 1 of the present embodiment, the attachment/detachment mechanism 13 includes two of the magnets 13c.

The two magnets 13c are respectively disposed at both end portions (both side portions), in the lateral direction (width direction), of the housing 12a. The magnets 13c are stuck to the outer surface of the door portion 101 via the cover portion 14 described above with reference to FIG. 3 and FIG. 4. The magnet 13c is attachable to and detachable from the outer surface of the door portion 101. Therefore, the attachment/detachment mechanism 13 (magnets 13c) temporarily fixes the housing 12a (support body 12) to the cooking apparatus 100.

The fifth embodiment of the present invention have been described above with reference to FIG. 20. Similarly to the first embodiment, according to the present embodiment, since the imaging apparatus 1 is attachable to and detachable from the cooking apparatus 100, the burden on the developer of the cooking apparatus 100 does not increase.

Note that, in the present embodiment, the two magnets 13c are stuck to the door portion 101 at the sides of the window portion 102. However, the positions at which the two magnets 13c are stuck to the door portion 101 are not particularly limited as long as the imaging apparatus 1 can be attached to the cooking apparatus 100.

Further, the number of the magnets 13c is not limited to two. The number of the magnets 13c is not particularly limited as long as the imaging apparatus 1 can be attached to the cooking apparatus 100. For example, the number of the magnets 13c may be one, or three or more.

### Sixth Embodiment

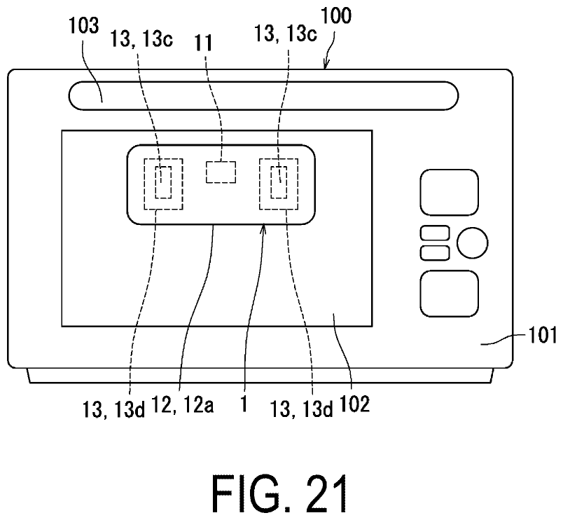

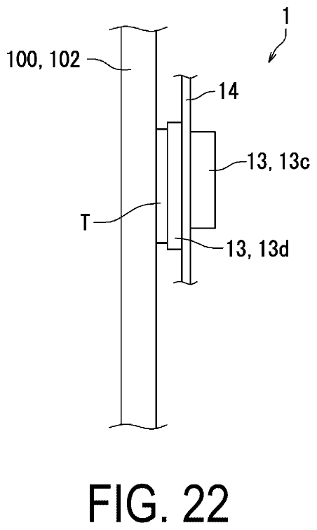

Next, a sixth embodiment of the present invention will be described with reference to FIG. 21 and FIG. 22. Note that elements different from those of the first to fifth embodiments will be described, and description of the same elements as those of the first to fifth embodiments will be omitted. In the sixth embodiment, the configuration of the attachment/detachment mechanism 13 is different from those of the first to fifth embodiments.

FIG. 21 is a front view illustrating the cooking apparatus 100 to which the imaging apparatus 1 of the present embodiment is temporarily fixed. FIG. 22 is a side view illustrating a configuration of the imaging apparatus 1 temporarily fixed to the window portion 102 of the cooking apparatus 100. Specifically, FIG. 22 illustrates a configuration of the attachment/detachment mechanism 13. As illustrated in FIG. 21 and FIG. 22, in the imaging apparatus 1 of the present embodiment, the attachment/detachment mechanism 13 includes two of the magnets 13c and two metal plates 13d.

As illustrated in FIG. 22, the surface of the metal plate 13d on the window portion 102 side is adhered to the window portion 102 by, for example, a double-sided tape T. The magnet 13c is stuck to the metal plate 13d via the cover portion 14. The magnet 13c is attachable to and detachable from the metal plate 13d fixed to the window portion 102. Therefore, the attachment/detachment mechanism 13 (magnets 13c and metal plates 13d) temporarily fixes the housing 12a (support body 12) to the cooking apparatus 100.

The sixth embodiment of the present invention has been described above with reference to FIG. 21 to FIG. 22. Similarly to the first embodiment, according to the present embodiment, since the imaging apparatus 1 is attachable to and detachable from the cooking apparatus 100, the burden on the developer of the cooking apparatus 100 does not increase. Further, according to the present embodiment, the imaging apparatus 1 can be attached to the window portion 102 of the cooking apparatus 100. Therefore, the dimension of the imaging apparatus 1 in the width direction is unlikely to increase.

Note that the number of the magnets 13c is not limited to two. The number of the magnets 13c is not particularly limited as long as the imaging apparatus 1 can be attached to the cooking apparatus 100. For example, the number of the magnets 13c may be one, or three or more.

Further, the shape of the metal plate 13d is not particularly limited. The metal plate 13d may have any shape as long as the magnet 13c can be stuck to the metal plate 13d.

Further, the number of the metal plates 13d is not limited to the number of the magnets 13c. The number of the metal plates 13d may be less than the number of the magnets 13c. For example, depending on the shape of the metal plate 13d, two of the magnets 13c can be stuck to one of the metal plates 13d.

Further, the dimensions of the metal plate 13d are not limited to the dimensions illustrated in FIG. 21. By increasing the dimensions of the metal plate 13d, the positions at which the magnets 13c are stuck to can be adjusted within a range of the metal plate 13d, and the position at which the imaging apparatus 1 is temporarily fixed to the cooking apparatus 10 can be adjusted.

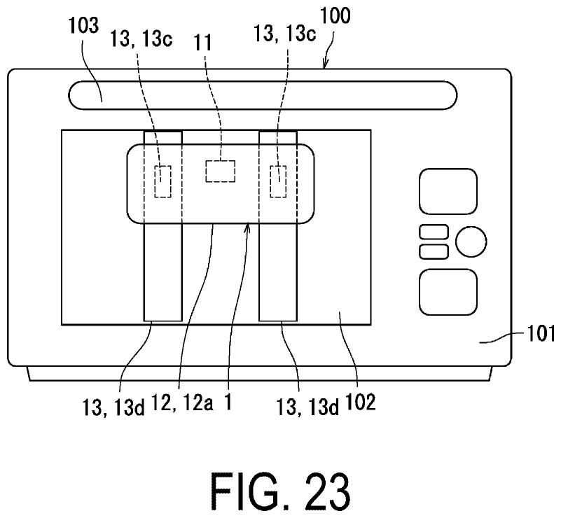

A modified example of the metal plate 13d will be described below with reference to FIG. 23. FIG. 23 is a diagram illustrating the modified example of the metal plate 13d. As illustrated in FIG. 23, the metal plate 13d may have, for example, an elongated shape.

In the example illustrated in FIG. 23, the metal plate 13d is adhered to the window portion 102 such that the longitudinal direction of the metal plate 13d extends along the up-down direction. Therefore, the position of the imaging apparatus 1 can be adjusted along the up-down direction by adjusting the positions at which the magnets 13c are stuck to the metal plates 13d along the up-down direction. Therefore, for example, when the cooking apparatus 100 is the cooking apparatus that can perform cooking at the plurality of rack positions arranged in the up-down direction in the cooking chamber 105, the image of the food being cooked at any rack position among the plurality of rack positions can be captured.

Note that, in the example illustrated in FIG. 23, the metal plate 13d is adhered to the window portion 102 such that the longitudinal direction of the metal plate 13d is along the up-down direction. However the orientation of the longitudinal direction of the metal plate 13d is not limited to the up-down direction. For example, the metal plate 13d may be adhered to the window portion 102 such that the longitudinal direction of the metal plate 13d extends along the left-right direction.

### Seventh Embodiment

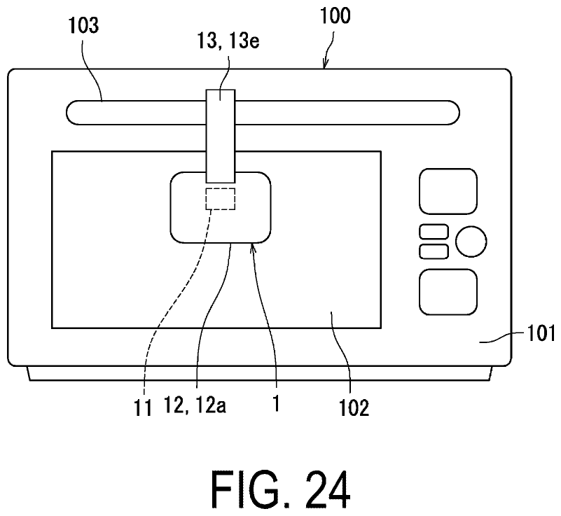

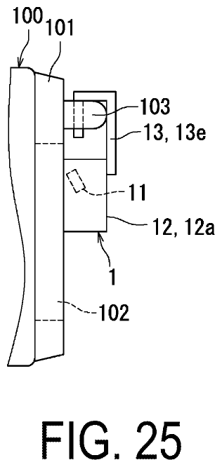

Next, a seventh embodiment of the present invention will be described with reference to FIG. 24 and FIG. 25. Note that elements different from those of the first to sixth embodiments will be described, and description of the same elements as those of the first to sixth embodiments will be omitted. In the seventh embodiment, the configuration of the attachment/detachment mechanism 13 is different from those of the first to sixth embodiments.

FIG. 24 is a front view illustrating the cooking apparatus 100 to which the imaging apparatus 1 of the present embodiment is temporarily fixed. FIG. 25 is a side view illustrating the imaging apparatus 1 temporarily fixed to the cooking apparatus 100. As illustrated in FIG. 24 and FIG. 25, in the imaging apparatus 1 of the present embodiment, the attachment/detachment mechanism 13 includes a hanging portion 13e.

The hanging portion 13e is supported by the support body 12 (housing 12a). The hanging portion 13e protrudes upward from the support body 12 (housing 12a). A tip portion of the hanging portion 13e is in a hook shape. A tip portion (hook portion) of the hanging portion 13e is hooked on the handle portion 103 of the cooking apparatus 100. The hanging portion 13e is attachable to and detachable from the handle portion 103. Therefore, the attachment/detachment mechanism 13 (hanging portion 13e) temporarily fixes the housing 12a (support body 12) to the cooking apparatus 100.

The seventh embodiment of the present invention has been described above with reference to FIG. 24 and FIG. 25. Similarly to the first embodiment, according to the present embodiment, since the imaging apparatus 1 is attachable to and detachable from the cooking apparatus 100, the burden on the developer of the cooking apparatus 100 does not increase.

Note that the number of the hanging portion 13e is not limited to one. The number of the hanging portion 13e is not particularly limited as long as the imaging apparatus 1 can be attached to the cooking apparatus 100. For example, the number of the hanging portion 13e may be two or more.

The embodiments of the present invention have been described above with reference to the accompanying drawings (FIG. 1 to FIG. 25). However, the present invention is not limited to the embodiments described above, and may be implemented in various modes without departing from the gist thereof. The plurality of constituent elements disclosed in the above embodiments may be appropriately changed. For example, a certain constituent element among all the constituent elements described in a certain embodiment may be added to the constituent elements of another embodiment, or some constituent elements among all the constituent elements described in a certain embodiment may be removed from the embodiment.

For facilitating the understanding of the invention, the drawings schematically illustrate main constituent elements, and the thickness, length, number, interval and the like of each of the illustrated constituent elements may differ from an actual thickness, length, number, interval and the like for the sake of convenience in creating the drawings. The configuration of each of the constituent elements described in the above embodiments is merely an example, is not limited to any specific configuration, and can be modified in various ways within a range that does not substantially depart from the advantage of the present invention.

For example, although the interface unit 23 includes the media slot 23a in the embodiments described above with reference to FIG. 1 to FIG. 25, the interface unit 23 is not limited to the media slot 23a. The interface unit 23 may be able to access the storage medium M. For example, the interface unit 23 may include a universal serial bus (USB) interface unit, instead of the media slot 23a or in addition to the media slot 23a.

For example, a USB memory is connected to the USB interface unit. Alternatively, one connector of a USB cable is connected to the USB interface unit. The other connector of the USB cable is connected to a storage device. The storage device is not particularly limited as long as it is a device which can store data. For example, the storage device may be a hard disk drive (HDD) device. Alternatively, the storage device may be a personal computer (PC).

In the embodiments described above with reference to FIG. 1 to FIG. 25, the power button 18, the recording button 19, the brightness adjustment button 20, and the zoom/wide button 21 are provided at the rear surface of the housing 12a, but the power button 18, the recording button 19, the brightness adjustment button 20, and the zoom/wide button 21 may be provided at a surface other than the rear surface of the housing 12a. For example, the power button 18, the recording button 19, the brightness adjustment button 20, and the zoom/wide button 21 may be provided at the upper surface of the housing 12a. Further, the power button 18, the recording button 19, the brightness adjustment button 20, and the zoom/wide button 21 may be provided at a plurality of surfaces of the housing 12a in a dispersed manner.

In the embodiments described above with reference to FIG. 1 to FIG. 25, the lighting unit 22 is provided at the rear surface of the housing 12a, but the lighting unit 22 may be provided at a surface other than the rear surface of the housing 12a. For example, the lighting unit 22 may be provided at the upper surface of the housing 12a.

In the embodiments described above with reference to FIG. 1 to FIG. 25, the light amount of the light emitted from the illumination unit 15 is changed in accordance with the instruction of the user, but the imaging apparatus 1 may change the light amount of the light emitted from the illumination unit 15 without relying on the instruction of the user. Specifically, the imaging apparatus 1 may further include a sensor that detects the brightness of the viewing range R of the imaging device 11, and the control unit 27 may control the light amount of the light emitted from the illumination unit 15 based on an output from the sensor.

In the embodiments described above with reference to FIG. 1 to FIG. 25, the imaging apparatus 1 is temporarily fixed to the cooking apparatus 100, but an attachment object to which the imaging apparatus 1 is temporarily fixed is not limited to the cooking apparatus 100. Specifically, the attachment object to which the imaging apparatus 1 is temporarily fixed may include a transparent member and may be configured such that one side of the transparent member is visible from the other side thereof. For example, the attachment object to which the imaging apparatus 1 is temporarily fixed includes a water tank, an insect cage, a train, a passenger car, and an airplane.

For example, when the imaging apparatus 1 is temporarily fixed to the water tank, the imaging apparatus 1 may capture an image of the interior of the water tank from the outside through a transparent case of the water tank. When the imaging apparatus 1 is temporarily fixed to the insect cage, the imaging apparatus 1 may capture an image of the interior of the insect cage from the outside through a transparent case of the insect cage or a window portion of the insect cage. When the imaging apparatus 1 is temporarily fixed to the train, the passenger car, or the airplane, the imaging apparatus 1 may capture an image of the outside of the train, the passenger car, or the airplane from inside thereof, through a window of the train, the passenger car, or the airplane.

### INDUSTRIAL APPLICABILITY

The present invention is useful for capturing a picture of cooking, for example.

### REFERENCE SIGNS LIST

1 Imaging apparatus
11 Imaging device
12 Support body
13 Attachment/detachment mechanism
15 Illumination unit
16 Imaging direction adjustment mechanism
17 Partition wall
25 Wireless communication unit
26 Secondary battery
27 Control unit
28 First self-standing mechanism
29 Second self-standing mechanism
100 Cooking apparatus
102 Window portion
105 Cooking chamber
113 Viewing range adjustment mechanism
291c Posture adjustment mechanism
R Viewing range
VA Viewing angle
VD Viewing direction

1. An imaging apparatus comprising:
an imaging device configured to perform image capture and generate imaging data;
a support body configured to support the imaging device; and
an attachment/detachment mechanism configured to temporarily fix a cooking apparatus to the support body,
wherein the cooking apparatus includes a cooking space in which food is cooked, and a window portion causing the cooking space to be visible, and
the attachment/detachment mechanism temporarily fixes the support body at a position at which an image of the cooking space is capturable by the imaging device through the window portion.

2. The imaging apparatus according to claim 1, further comprising:
a wireless communication unit configured to wirelessly transmit the imaging data.

3. The imaging apparatus according to claim 1, further comprising:
an illumination unit configured to project light into a viewing range of the imaging device.

4. The imaging apparatus according to claim 3, further comprising:
a control unit configured to control a light amount of the light emitted from the illumination unit.

5. The imaging apparatus according to claim 4, further comprising:
a wireless communication unit configured to wirelessly receive a light amount instruction signal instructing the light amount of the light emitted from the illumination unit to be changed,
wherein the control unit controls the light amount of the light emitted from the illumination unit based on the light amount instruction signal.

6. The imaging apparatus according to claim 3, further comprising:
a partition wall disposed between the imaging device and the illumination unit.

7. The imaging apparatus according to claim 6,
wherein the partition wall has flexibility.

8. The imaging apparatus according claim 1,
wherein the imaging device includes a viewing range adjustment mechanism configured to adjust a viewing range of the imaging device.

9. The imaging apparatus according to claim 8, further comprising:
a wireless communication unit configured to wirelessly receive a viewing range instruction signal instructing the viewing range to be changed; and
a control unit configured to control the viewing range adjustment mechanism based on the viewing range instruction signal.

10. The imaging apparatus according to claim 1, further comprising:
an imaging direction adjustment mechanism configured to adjust an attachment angle of the imaging device with respect to the support body.

11. The imaging apparatus according to claim 10, further comprising:
a wireless communication unit configured to wirelessly receive an attachment angle instruction signal instructing the attachment angle of the imaging device to be changed; and
a control unit configured to control the imaging direction adjustment mechanism based on the attachment angle instruction signal.

12. The imaging apparatus according to claim 1, further comprising:
a self-standing mechanism configured to cause the support body to stand by itself.

13. The imaging apparatus according to claim 12,
wherein the self-standing mechanism includes a posture adjustment mechanism configured to adjust a posture of the support body.

14. The imaging apparatus according to claim 1, further comprising:
a power supply interface unit to which an external power supply line is detachably connected.

15. The imaging apparatus according to claim 14, further comprising:
a secondary battery configured to store power supplied to the power supply interface unit.

16. The imaging apparatus according to claim 1, further comprising:
a blackout portion configured to suppress light reflected by the window portion of the cooking apparatus from entering a viewing range of the imaging device.

17. The imaging apparatus according to claim 16,
wherein the blackout portion is a portion of the support body.

18. The imaging apparatus according to claim 16,
wherein the blackout portion has flexibility.
